(19) United States
(12) Patent Application Publication
(10) Pub. No.: US 2009/0129229 A1
(43) Pub. Date: May 21, 2009

(54) METHOD AND APPARATUS FOR REPRODUCING DATA

(75) Inventors: Hyun-soo PARK, Seoul (KR); In-ho Hwang, Seongnam-si (KR); Hui Zhao, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/117,253

(22) Filed: May 8, 2008

(30) Foreign Application Priority Data
Nov. 19, 2007 (KR) 2007-118099

(51) Int. Cl. G11B 20/10

(52) U.S. Cl. 369/59.22

(57) ABSTRACT

A method and apparatus for reproducing data, by which the quality of signals input to a Viterbi decoder are improved by using a two-step equalizer, and the Viterbi decoder is operated in an optimum state so that the quality of reproduction signals is improved, the apparatus including: a first equalizing unit to compensate for frequency gain properties of an input signal according to predetermined levels, a second equalizing unit to reduce noise of the input signal processed by the first equalizing unit, and a Viterbi decoder to Viterbi-decode the input signal processed by the second equalizing unit to output a binary signal corresponding to the data.

### CROSS-REFERENCE TO RELATED APPLICATION

This application claims the benefit of Korean Application No. 2007-118099, filed Nov. 19, 2007, in the Korean Intellectual Property Office, the disclosure of which is incorporated herein by reference.

### BACKGROUND OF THE INVENTION

1. Field of the Invention

Aspects of the present invention relate to a method and apparatus for reproducing data, and more particularly, to a method and apparatus for reproducing data by which the quality of reproduction signals is improved using a Viterbi decoder.

2. Description of the Related Art

Optical disc drives record and/or reproduce data to/from a disc. Specifically, during a recording operation, the optical disc drives write binary signals to the surface of the disc. However, due to the physical and optical characteristics of the disc, signals read from the surface of the disc (so-called RF signals) have properties of analog signals. Thus, in order to reproduce the binary signals, a binarization function to convert the RF signals into digital signals is necessary in the optical disc drives.

The binarization function may be implemented by various methods. According to one conventional method, a binary signal having a smallest error is detected by performing the binarization function using a Viterbi decoder. However, since the types of optical discs are diverse, the shapes of signals input to the Viterbi decoder are diverse. Furthermore, as the recording density of the optical disc increases, the quality of the signals input to the Viterbi decoder is degraded. As such, it is difficult to adjust the operating state of the Viterbi decoder to an optimum state and, as a result, the quality of reproduction signals is often degraded.

### SUMMARY OF THE INVENTION

Aspects of the present invention provide a method and apparatus for reproducing data, by which the quality of signals input to a Viterbi decoder is improved and the Viterbi decoder is operated in an optimum state so that the quality of reproduction signals is improved. Aspects of the present invention also provide a method and apparatus for reproducing data, by which the frequencies of signals input to a Viterbi decoder are compensated for, noise is reduced, and the Viterbi decoder is operated in an optimum state so that the quality of reproduction signals is improved.

According to an aspect of the present invention, there is provided an apparatus for reproducing data of an input signal, the apparatus including: a first equalizing unit to compensate for frequency gain properties of the input signal according to predetermined levels; a second equalizing unit to reduce noise of the input signal processed by the first equalizing unit; and a Viterbi decoder to Viterbi-decode the input signal processed by the second equalizing unit to output a binary signal corresponding to the data.

The first equalizing unit may include: a first equalizer to equalize the input signal so that the frequency gain properties of the input signal are compensated for; and a first coefficient updating unit to update coefficients of the first equalizer based on the predetermined levels, the input signal of the first equalizer, an output signal of the first equalizer, and an output signal of the Viterbi decoder.

The predetermined levels may be determined based on the bit error rate (BER) measuring result of the Viterbi decoder with respect to at least one medium from which data is reproduced.

The second equalizing unit may include: a second equalizer to equalize the input signal processed by the first equalizing unit so as to reduce the noise of the input signal processed by the first equalizing unit; a channel identifier to detect reference levels of the Viterbi decoder based on an output signal of the Viterbi decoder and the input signal of the second equalizer; and a second coefficient updating unit to update coefficients of the second equalizer based on the input signal of the second equalizer, an output signal of the second equalizer, the reference levels, and the output signal of the Viterbi decoder.

The first coefficient updating unit and/or the second coefficient updating unit may update the coefficients of the first equalizer and the coefficients of the second equalizer using one of a minimum square error (MSE) algorithm and a least mean square (LMS) algorithm.

The first equalizer and/or the second equalizer may be configured as a digital filter.

According to another aspect of the present invention, there is provided a method of reproducing data of an input signal, the method including: first equalizing that the input signal to compensate for frequency gain properties the input signal according to predetermined levels; second equalizing the first equalized input signal to reduce a noise of the first equalized signal; and Viterbi-decoding the second equalized signal to output a binary signal corresponding to the data.

According to another aspect of the present invention, there is provided an apparatus for reproducing data in an input signal, the apparatus including: an equalizing unit to compensate for frequency gain properties of the input signal according to predetermined levels; and a Viterbi decoder to Viterbi-decode the input signal processed by the equalizing unit to output a binary signal corresponding to the data.

According to another aspect of the present invention, there is provided a method of reproducing data in an input signal, the method including: equalizing the input signal to compensate for frequency gain properties of the input signal according to predetermined levels; and Viterbi-decoding the equalized input signal to output a binary signal corresponding to the data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a functional block diagram of an apparatus for reproducing data according to an embodiment of the present invention;

FIG. 2 illustrates an implementation example of a first equalizer and a second equalizer shown in FIG. 1;

FIG. 3 illustrates an implementation example of a first coefficient updating unit shown in FIG. 1;

FIG. 4 illustrates an implementation example of a channel identifier shown in FIG. 1;

FIG. 5 illustrates an implementation example of a second coefficient updating unit shown in FIG. 1; and

FIG. 6 is a flowchart illustrating a method of reproducing data according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention provide a method and apparatus for reproducing data from a medium using a two-step equalizer by which frequency gain properties of signals input to a Viterbi decoder are compensated for, noise is reduced, and the Viterbi decoder is operated in an optimum state regardless of a type of the medium and a recording density of the medium.

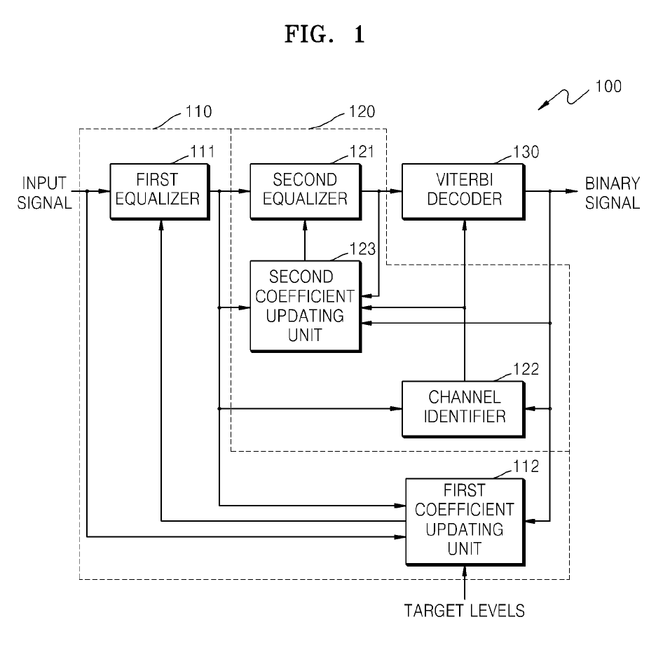

FIG. 1 is a functional block diagram of an apparatus 100 for reproducing data according to an embodiment of the present invention. Referring to FIG. 1, the apparatus 100 includes a first equalizing unit 110, a second equalizing unit 120, and a Viterbi decoder 130.

The first equalizing unit 110 compensates for frequency gain properties of input signals according to predetermined levels. That is, the first equalizing unit 110 adaptively equalizes input signals to predetermined levels to adjust modulation transfer function (MTF) properties of the input signals based on desired conditions. In particular, when the input signals have radio frequencies (i.e., 2T which is the shortest T), the first equalizing unit 110 may compensate for the frequency gain properties of the input signals so as to improve the frequency gain properties.

As such, if a medium for reproducing data is changed or if a write strategy for the medium is changed so that the level values of the input signals are changed, bit error rates (BER) of the input signals may be increased. Similarly, if there is a change in the reproduction signals because of a difference in reflectivity of each layer of the medium, BERs of the input signals may be increased. The predetermined levels may be determined according to performance results when experimentally changing the MTF. In other words, the predetermined levels may be determined based on the BER measuring results of the Viterbi decoder 130 for various media. For example, as the amplitudes of the input signal with a period of 2T increase, the predetermined levels may be determined as described above. The predetermined levels are target levels, as shown in FIG. 1.

The input signals are read from the medium (not shown) such as a disc, and may be signals that are obtained by converting the read signals into digital signals using an analog/digital signal converter (not shown) or may be signals that are obtained by compensating for DC components of the digital signals in an optimum state (or by removing Offset).

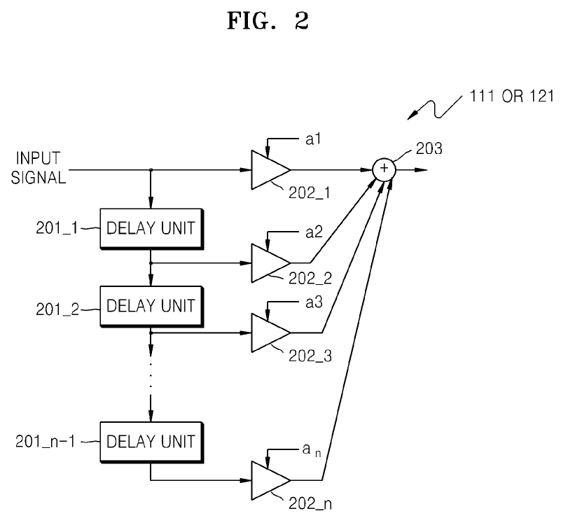

In order to perform the above-described operations, the first equalizing unit 110 includes a first equalizer 111 and a first coefficient updating unit 112. The first equalizer 111 equalizes input signals so that the frequency gain properties of the input signals are compensated for. In other words, the first equalizer 111 changes the amplitudes of the input signals according to coefficients that are changed according to the predetermined levels, so as to improve the frequency gain properties of the input signals. To this end, the first equalizer 11 may, although not necessarily, be a finite impulse response (FIR) filter, as illustrated in FIG. 2. Referring to FIG. 2, the first equalizer 111 includes a plurality of delay units 201_1 through 201_{—}n−1, a plurality of multipliers 202_1 through 202_{—}n, and an adder 203.

The delay units 201_1 through 201_{—}n−1 delay the input signals according to unit clocks (or system clocks). The multipliers 202_1 through 202_{—}n multiply the input signals and the delayed signals by coefficients a1 through an. The coefficients a1 through an, which may be in the range of real numbers including 0, are provided by the first coefficient updating unit 112. The adder 203 adds outputs of the multipliers 202_1 through 202_{—}n and outputs the result.

The first coefficient updating unit 112 updates the coefficients of the first equalizer 111 based on the predetermined levels (or target levels), the input signals of the first equalizer 111, the output signals of the first equalizer 111, and the output signals of the Viterbi decoder 130. For example, the first coefficient updating unit 112 updates the coefficients a1 through an as shown in FIG. 2.

The first coefficient updating unit 112 updates the coefficients of the first equalizer 111 using one of a minimum square error (MSE) algorithm and a least mean square (LMS) algorithm. When the first coefficient updating unit 112 updates the coefficients of the first equalizer 111 using the LMS algorithm, the updated coefficients may be obtained using equation 1:

Wₖ₊₁=Wₖ+2μeₖxₖ,

where Wₖ₊₁ represents new coefficients to be input to the first equalizer 111, k represents time, μ represents parameters for determining a following speed, eₖ represents error signals indicating a difference between the predetermined levels (or target levels) detected based on the output signals of the Viterbi decoder 130 and the output signals of the first equalizer 111, and xₖ represents input signals of the first equalizer 111.

Here, since k represents time, Wₖ₊₁ represents a1 through an at time k+1. Since Wₖ represents the previous coefficients of the first equalizer 111, Wₖ represents a1 through an at time k. Furthermore, μ has real number values and may be adjusted by a microcomputer (not shown) or other control units (not shown) included in a system in which the apparatus 100 for reproducing data according to aspects of the present invention is used. In other words, μ may be determined according to the operating speed of the system.

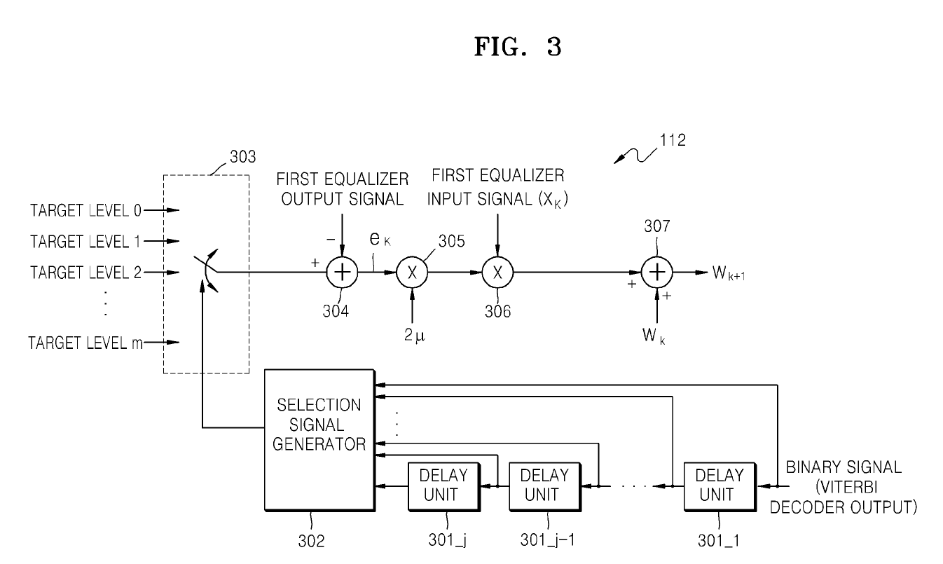

When the coefficients of the first equalizer 111 are updated using the LMS algorithm defined in equation 1, the first coefficient updating unit 112 may be configured accordingly. For example, FIG. 3 illustrates a possible implementation of a first coefficient updating unit 112 according to aspects of the present invention. Referring to FIG. 3, the first coefficient updating unit 112 includes a plurality of delay units 301_1 through 301_{—}j, a selection signal generator 302, a level selector 303, a subtractor 304, a plurality of multipliers 305 and 306, and an adder 307.

The delay units 301_1 through 301_{—}j delay binary signals output from the Viterbi decoder 130 according to unit clocks (or system clocks). The delay units 301_1 through 301_{—}j are used to output delayed selection signals that are combined with binary signals output from the Viterbi decoder 130.

The selection signal generator 302 generates selection signals in which the input binary signals and the delayed signals are combined. In FIG. 3, the selection signal generator 302 may generate 2^{j+1} selection signals due to j delay units. For example, when j is 2, the selection signal generator 302 may generate 2³ selection signals. That is, when there are 2³ generable selection signals, the selection signal generator 302 may generate one of 000, 001, 010, 011, 100, 110, and 111 as a selection signal.

The level selector 303 selects one of the target levels 0 through m, which are previously set by the generated selection signal. The target levels 0 through m correspond to predetermined levels 0 through m. When the 23 selection signals are generated in the selection signal generator 302, as described above, m is 7. Accordingly, when m is 7, the level selector 303 selects and outputs one of the 8 target levels.

The subtractor 304 detects an error signal eₖ in equation 1. Specifically, the subtractor 304 detects a difference between the level values transmitted from the level selector 303 and the output signals of the first equalizer 111. Thus, the subtractor 304 may be defined as an error signal detector.

A first multiplier 305 multiplies the previously-set 2μ by the error signal eₖ detected by the subtractor 304 and outputs the multiplied result. Thus, signals output from the first multiplier 305 correspond to 2μeₖ defined in equation 1 above.

A second multiplier 306 multiplies 2μeₖ output from the first multiplier 305 by an input signal xₖ of the first equalizer 111. Thus, signals output from the second multiplier 306 correspond to 2μeₖxₖ defined in equation 1 above.

The adder 307 adds the previous coefficient provided to the first equalizer 111 to 2μeₖxₖ output from the multiplier 306, as defined in equation 1, and outputs a new coefficient Wₖ₊₁. The output new coefficient Wₖ₊₁ is provided to the first equalizer 111. Accordingly, the first equalizer 111 equalizes input signals according to the new coefficient Wₖ₊₁.

Referring back to FIG. 1, the second equalizing unit 120 equalizes the signals output from the first equalizing unit 110 so as to reduce noise thereof. To this end, the second equalizing unit 120 includes a second equalizer 121, a channel identifier 122, and a second coefficient updating unit 123.

The second equalizer 121 equalizes the signals output from the first equalizer 111 so as to reduce noise thereof. Like the first equalizer 111, the second equalizer 121 may also be an FIR filter. That is, the second equalizer 121 may be configured like the first equalizer 111, as shown in FIG. 1, including the delay units 201_1 through 201_{—}n−1, the multipliers 202_1 through 202_{—}n, and the adder 203.

The channel identifier 122 detects an optimum reference level of the Viterbi decoder 130 based on the output signals of the Viterbi decoder 130 and the input signals of the second equalizer 121. The optimum reference level is used to operate the Viterbi decoder 130 so that the Viterbi decoder 130 obtains optimum binary signals with respect to input signals.

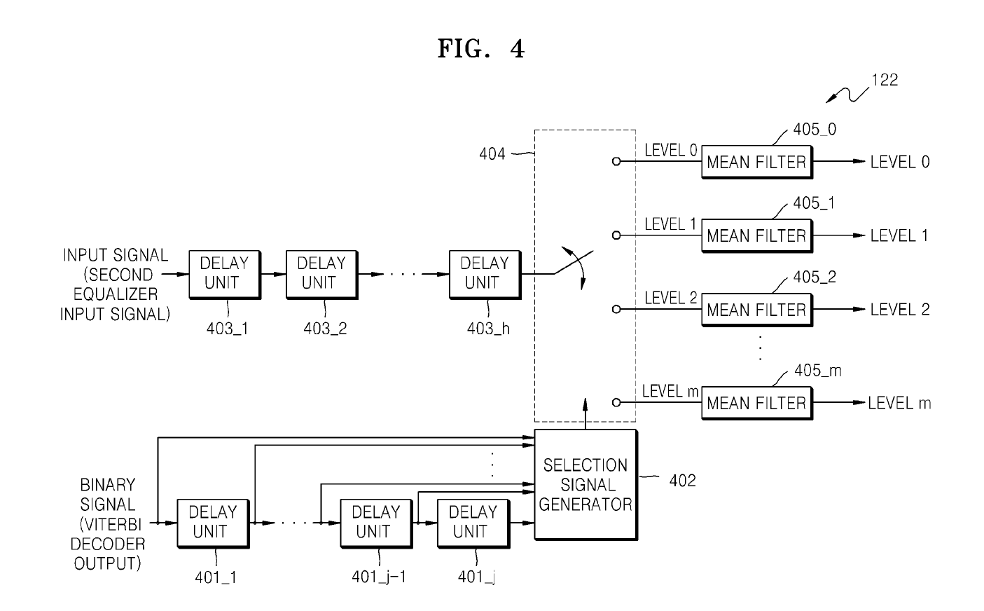

To this end, the channel identifier 122 may be configured appropriately. For example, FIG. 4 illustrates an implementation example of a channel identifier 122 according to aspects of the present invention. Referring to FIG. 4, the channel identifier 122 includes a plurality of first delay units 401_1 through 401_{—}j, a selection signal generator 402, a plurality of second delay units 403_1 through 403_{—}h, a level selector 404, and a plurality of mean filters 405_0 through 405_{—}m.

The first delay units 401_1 through 401_{—}j and the selection signal generator 402 respectively operate in the same way as the delay units 301_1 through out 301_{—}j and the selection signal generator 302 shown in FIG. 3. Thus, the first delay units 401_1 through 401 and the selection signal generator 402 combine the binary signals output from the Viterbi decoder 130 to generate selection signals. Accordingly, the first delay units 401_1 through 401_{—}j and the selection signal generator 402 may be defined as a selection signal generating unit.

The second delay units 403_1 through 403_{—}h delay the input signals so as to synchronize the selection signals generated by the selection signal generator 402 based on the input signals of the second equalizer 121 and the binary signals output from the Viterbi decoder 130. In other words, in order to select the input signals corresponding to the binary signals output from the Viterbi decoder 130, the input signals may be delayed by the time corresponding to an operation period at the Viterbi decoder 130. The second delay units 403_1 through 403_{—}h delay the input signals according to unit clocks (or system clocks).

The level selector 404 selects the level of a signal output from the second delay unit 403_{—}h according to the selection signal output from the selection signal generator 402. For example, when the selection signal generator 402 generates “000”, the level generator 404 selects the level of the signal output from the second delay unit 403_{—}h as “level 0.” As such, the signal output from the second delay unit 403_{—}h is transmitted to the mean filter 405_0. As another example, when the selection signal generator 402 generates “010”, the level selector 404 selects the level of the signal output from the second delay unit 403_{—}h as “level 2.” As such, the signal output from the second delay unit 403_{—}h is transmitted to the mean filter 405_2. When 2³ selection signals can be generated in the selection signal generator 402, as described in FIG. 3, m is 7 in FIG. 4. However, the m of FIG. 3 and the m of FIG. 4 may be defined as different values.

The above-described first delay units 401_1 through 401_{—}j, the selection signal generator 402, the second delay units 403_1 through 403_{—}h, and the level selector 404 may be defined as an input signal separating unit that separates the input signals based on the binary signals output from the Viterbi decoder 130.

The mean filters 405_0 through 405_{—}m obtain mean values of the input signals. Specifically, the mean filters 405_0 through 405_{—}m obtain mean values of input levels using equation 2:

Level Value=Previous Level Value+(Input Signal−Previous Level Value)/Constant,

where the Level Value is a mean value that is obtained by calculating an input signal from each of the mean filters 405_0 through 405_{—}m during a predetermined period. The Level Value may be defined as an updated level value, and the predetermined period may be set to be long. Furthermore, the Previous Level Value is a mean value that is obtained by calculating an input signal from each of the mean filters 405_0 through 405_{—}m during the previous period. The Input Signal is a signal that is transmitted from the second delay unit 403_{—}h, and may be defined as a delayed input signal. Also, the Constant may be determined experimentally in consideration of the reproduction speed of a system in which the apparatus 100 for reproducing data is used. That is, as the Constant is increased, the level value of equation 2 decreases and the reproduction speed of the system is reduced. The mean filters 405_0 through 405_{—}m may be replaced with low pass filters (LPF).

Referring back to FIG. 1, the channel identifier 122 transmits one of the level values 0 through m to the second coefficient updating unit 123 and the Viterbi decoder 130, respectively. In this case, the transmitted level value is a reference level of the Viterbi decoder 130.

The second coefficient updating unit 123 updates the coefficients of the second equalizer 121 based on the input signals of the second equalizer 121, the output signals of the second equalizer 121, the reference levels transmitted from the channel identifier 122, and the binary signals output from the Viterbi decoder 130.

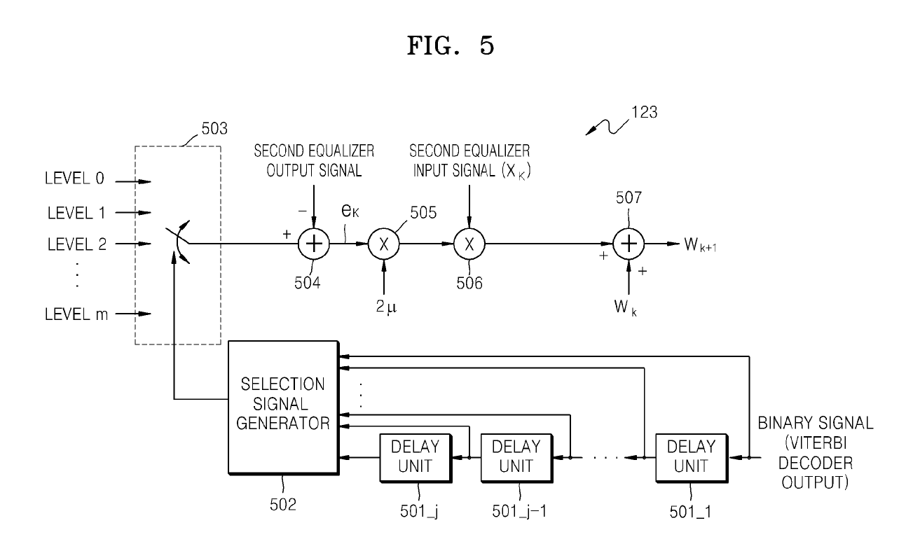

To this end, the second coefficient updating unit 123 may be configured appropriately. For example, FIG. 5 illustrates an implementation example of a second coefficient updating unit according to aspects of the present invention. Referring to FIG. 5, the second coefficient updating unit 123 includes a plurality of delay units 501_1 through 501_{—}j, a selection signal generator 502, a level selector 503, a subtractor 504, a plurality of multipliers 505 and 506, and an adder 507. The configuration and operation of the second coefficient updating unit 123, shown in FIG. 5, is the same as that of the first coefficient updating unit 112 shown in FIG. 3, except that levels that can be selected by the level selector 503 are in the range of 0 through m of level values output from the channel identifier 122. As such, the second equalizer 121 equalizes a signal output from the first equalizer 111 to eliminate noise according to the new coefficient Wₖ₊₁ as defined in equation 1 above.

Referring back to FIG. 1, the Viterbi decoder 130 performs a Viterbi-decode operation on the signal output from the second equalizer 121 of the second equalizing unit 120 based on the reference level provided by the channel identifier 122. In other words, the Viterbi decoder 130 has a structure in which the statistical characteristic of the input signal is determined according to the reference level, and an optimum binary signal having a small error is obtained.

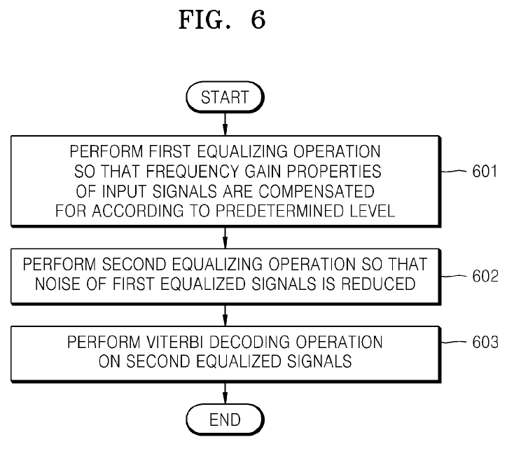

FIG. 6 is a flowchart illustrating a method of reproducing data according to an embodiment of the present invention. Referring to FIG. 6, a first equalizing operation is performed so that the frequency gain properties of input signals are compensated for according to predetermined levels in operation 601. Specifically, in the first equalizing operation, first equalizing coefficients are updated based on the predetermined levels, signals before first equalizing, signals after first equalizing, and Viterbi-decoded signals, as described in the first equalizing unit 110 of FIG. 1. The predetermined levels correspond to the target levels of FIG. 1, the signals before first equalizing correspond to the input signals of the first equalizer 111 of FIG. 1, the signals after first equalizing correspond to the output signals of the first equalizer 111, and the Viterbi-decoded signals correspond to the binary signals output from the Viterbi decoder 130 of FIG. 1. The updating of the first equalizing coefficients may be performed using an MSE algorithm or an LMS algorithm, as described in FIG. 1.

Next, a second equalizing operation is performed so that noise of the first equalized signal is reduced in operation 602. In the second equalizing operation, Viterbi decoding reference levels are detected based on the Viterbi-decoded signal and a signal before second equalizing. Then, second equalizing coefficients are updated based on the Viterbi decoding reference levels, the signals before second equalizing, signals after second equalizing, and the Viterbi-decoded signals. The Viterbi decoding reference levels correspond to the level values output from the channel identifier 122 of FIG. 1, the signals before second equalizing correspond to the input signals of the second equalizer 121 of FIG. 1, the signals after second equalizing correspond to the output signals of the second equalizer 121 of FIG. 1, and the Viterbi-decoded signals correspond to the binary signals output from the Viterbi decoder 130 of FIG. 1. The updating of the second equalizing coefficients may be performed using one of an MSE algorithm or an LMS algorithm.

Furthermore, the above-described first equalizing operation (operation 601) and second equalizing operation (operation 602) may be performed using the digital filter shown in FIG. 2.

Next, a Viterbi decoding operation is performed on the second equalized signal in operation 603 in such a way that the statistical characteristic of the input signals is determined according to the reference levels that are obtained by the channel identifier 122, and thus, an optimum binary signal having a small error is obtained. The input signal during the Viterbi decoding operation (operation 603) is the signal output by the second equalizing (operation 602).

Aspects of the present invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

In the method and apparatus for reproducing data using a plurality of equalizers according to aspects of the present invention, frequency gain properties of signals input to a Viterbi decoder are compensated for and noise input to the Viterbi decoder is reduced. Furthermore, the Viterbi decoder is operated in an optimum state regardless of the type of medium for reproducing data and the recording density of the medium such that the quality of reproduction signals can be improved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus for reproducing data in an input signal, the apparatus comprising:
a first equalizing unit to compensate for frequency gain properties of the input signal according to predetermined levels;
a second equalizing unit to reduce a noise of the input signal processed by the first equalizing unit; and
a Viterbi decoder to Viterbi-decode the input signal processed by the second equalizing unit to output a binary signal corresponding to the data.

2. The apparatus as claimed in claim 1, wherein the first equalizing unit comprises:
a first equalizer to equalize the input signal so that the frequency gain properties of the input signal are compensated for; and
a first coefficient updating unit to update coefficients of the first equalizer based on the predetermined levels, the input signal of the first equalizer, an output signal of the first equalizer, and an output signal of the Viterbi decoder.

3. The apparatus as claimed in claim 1, wherein the predetermined levels are determined based on a bit error rate (BER) measuring result of the Viterbi decoder with respect to at least one medium from which data is reproduced.

4. The apparatus as claimed in claim 2, wherein the first coefficient updating unit updates the coefficients of the first equalizer using a minimum square error (MSE) algorithm or a least mean square (LMS) algorithm.

5. The apparatus as claimed in claim 1, wherein the second equalizing unit comprises:
a second equalizer to equalize the input signal processed by the first equalizing unit so as to reduce the noise of the input signal;
a channel identifier to detect reference levels of the Viterbi decoder based on an output signal of the Viterbi decoder and the input signal processed by the first equalizing unit; and
a second coefficient updating unit to update coefficients of the second equalizer based on the input signal processed by the first equalizing unit, an output signal of the second equalizer, the reference levels, and the output signal of the Viterbi decoder.

6. The apparatus as claimed in claim 5, wherein the second coefficient updating unit updates the coefficients of the second equalizer using an MSE algorithm or an LMS algorithm.

7. The apparatus as claimed in claim 5, wherein the first equalizer and/or the second equalizer is configured as a digital filter.

8. The apparatus as claimed in claim 1, wherein the input signal is read from an optical disk.

9. A method of reproducing data in an input signal, the method comprising:
first equalizing the input signal to compensate for frequency gain properties of the input signal according to predetermined levels;
second equalizing the first equalized input signal to reduce a noise of the first equalized input signal; and
Viterbi-decoding the second equalized input signal to output a binary signal corresponding to the data.

10. The method as claimed in claim 9, wherein the first equalizing comprises updating first equalizing coefficients based on the predetermined levels, the input signal before the first equalizing, the input signal after the first equalizing, and the Viterbi-decoded signal.

11. The method as claimed in claim 9, wherein the predetermined levels are determined based on a bit error rate (BER) measuring result of a Viterbi decoder that performs the Viterbi-decoding with respect to at least one medium from which data is reproduced.

12. The method as claimed in claim 10, wherein the updating of the first equalizing coefficients comprises using a minimum square error (MSE) algorithm or a least mean square (LMS) algorithm.

13. The method as claimed in claim 9, wherein the second equalizing comprises:
detecting Viterbi decoding reference levels based on the Viterbi-decoded signal and the first equalized input signal;
updating second equalizing coefficients based on the Viterbi decoding reference levels, the first equalized input signal, the second equalized input signal, and the Viterbi-decoded signal.

14. The method as claimed in claim 13, wherein the updating of the second coefficients comprises using an MSE algorithm or an LMS algorithm on the coefficients of the second equalizer.

15. The method as claimed in claim 13, wherein the first equalizing and/or the second equalizing is performed using a digital filter.

16. The method as claimed in claim 9, wherein the input signal is read from an optical disk.

17. An apparatus for reproducing data in an input signal, the apparatus comprising:
an equalizing unit to compensate for frequency gain properties of the input signal according to predetermined levels; and
a Viterbi decoder to Viterbi-decode the input signal processed by the equalizing unit to output a binary signal corresponding to the data,
wherein the equalizing unit comprises:
an equalizer to equalize the input signal so that the frequency gain properties of the input signal are compensated for; and
a coefficient updating unit to update coefficients of the equalizer based on the predetermined levels, the input signal of the equalizer, an output signal of the equalizer, and an output signal of the Viterbi decoder.

18. The apparatus as claimed in claim 17, wherein the predetermined levels are determined based on a bit error rate (BER) measuring result of the Viterbi decoder with respect to at least one medium from which data is reproduced.

19. The apparatus as claimed in claim 17, wherein the coefficient updating unit updates the coefficients of the equalizer using a minimum square error (MSE) algorithm or a least mean square (LMS) algorithm.

20. The apparatus as claimed in claim 17, wherein the input signal is read from an optical disk.

21. A method of reproducing data in an input signal, the method comprising:
equalizing the input signal to compensate for frequency gain properties of the input signal according to predetermined levels; and
Viterbi-decoding the equalized input signal to output a binary signal corresponding to the data,
wherein the equalizing comprises updating equalizing coefficients based on the predetermined levels, the input signal before the equalizing, the input signal after the equalizing, and the Viterbi-decoded signal.

22. The method as claimed in claim 21, wherein the predetermined levels are determined based on a bit error rate (BER) measuring result of a Viterbi decoder that performs the Viterbi-decoding with respect to at least one medium from which data is reproduced.

23. The method as claimed in claim 21, wherein the updating of the equalizing coefficients comprises using a minimum square error (MSE) algorithm or a least mean square (LMS) algorithm.
